(19) United States
(12) Patent Application Publication
(10) Pub. No.: US 2025/0181887 A1
(43) Pub. Date: Jun. 5, 2025

(54) PROCESSING NETWORK INPUTS USING PARTITIONED ATTENTION

(71) Applicant: DEEPMIND TECHNOLOGIES LIMITED, London (GB)

(72) Inventors: Adrià Recasens Continente, London (GB); Jason Jiachen Lin, Palo Alto, CA (US); Luyu Wang, Oakville (CA); Jean-Baptiste Alayrac, London (GB); Andrew Coulter Jaegle, London (GB); Joao Carreira, St. Albans (GB); Pauline Luc, London (GB); Antoine Miech, London (GB); Lucas De Freitas Smaira, London (GB); Ross Hemsley, London (GB); Andrew Zisserman, London (GB)

(21) Appl. No.: 18/844,875

(22) PCT Filed: Mar. 7, 2023
(86) PCT No.: PCT/EP2023/055753

§ 371 Date: Sep. 6, 2024

Related U.S. Application Data
(60) Provisional application No. 63/317,538, filed on Mar. 7, 2022.

(51) Int. Cl. G06N 3/04

(52) U.S. Cl. CPC G06N 3/04

(57) ABSTRACT

Methods, systems, and apparatus, including computer programs encoded on computer storage media, for processing network inputs using a neural network that implements partitioned attention.

### CROSS-REFERENCE TO RELATED APPLICATION

This application claims priority to U.S. Provisional Application No. 63/317,538, filed on Mar. 7, 2022. The disclosure of the prior application is considered part of and is incorporated by reference in the disclosure of this application.

### BACKGROUND

This specification relates to processing inputs using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that processes a network input that is partitioned into multiple disjoint partitions to generate a network output for a machine learning task.

For example, the network input can be a single, uni-modal tensor and each disjoint partition can be different non-overlapping region of the tensor.

As another example, the network input can be a multi-modal input that includes multiple different modalities and each partition can be a different one of the multiple modalities.

The subject matter described in this specification can be implemented in particular embodiments so as to realize one or more of the following advantages.

Attention-based models are appealing for multimodal processing because inputs from multiple modalities can be concatenated and fed to a single backbone network—thus requiring very little fusion engineering. The resulting representations, however, are fully entangled throughout the network, which may be problematic in several scenarios.

For example, contrastive learning has been shown to be an effective technique for leveraging unlabeled data to improve downstream performance on a variety of tasks. During training, multi-modal contrastive self-supervised learning requires independent features for each modality to operate, otherwise learning collapses. However, because the representations are entangled, there are not independent features that are suitable for being used as inputs to the contrastive.

Moreover, at inference, these models cannot effectively perform uni-modal tasks or processes inputs when one modality is missing.

This specification describes techniques for controlling how inputs from each modality are routed inside attention-based neural network in order to keep parts of the internal representations of the model modality-specific, i.e., based only on data from a single modality. In particular, this specification describes techniques that, for each modality, update a set of latent vectors for the modality using attention only over the latent vectors for the modality (and not for other modalities) while updating a set of fused latent vectors using information from all modalities.

This allows the system to effectively incorporate contrastive pre-training in order to improve performance on a variety of down-stream multi modal tasks. Moreover, this allows the system to effectively perform uni-modal inference or, more generally, still generate accurate outputs for the task even if data from one modality is missing.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example neural network system.

FIG. 2 is a flow diagram of an example process for processing a network input using the neural network.

FIG. 3 shows an example architecture of an attention block.

FIG. 4 shows another example architecture of an attention block.

FIG. 5 shows yet another example architecture of an attention block.

FIG. 6 shows the operation of the output block.

FIG. 7 shows various uses of the neural network, both during training and during inference.

Like reference numbers and designations in the various drawings indicate like elements.

### DETAILED DESCRIPTION

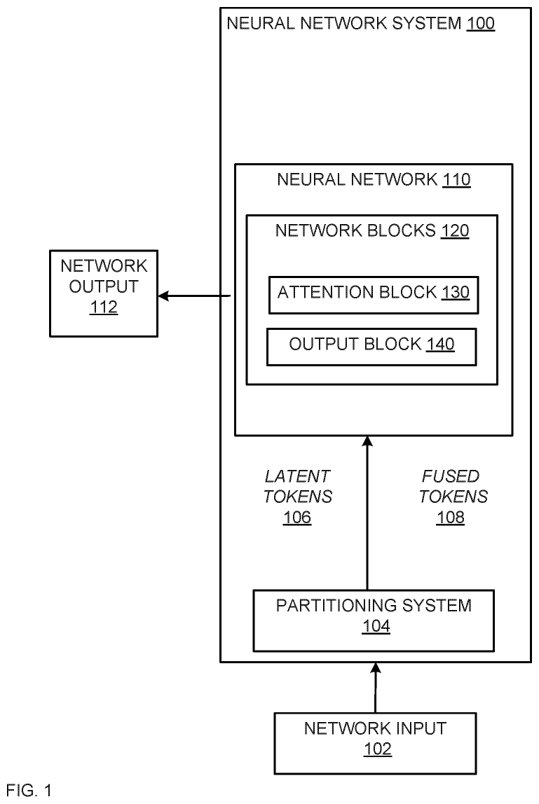

FIG. 1 is a diagram of an example neural network system 100. The neural network system 100 is an example of a system implemented as computer programs on one or more computers in one or more locations, in which the systems, components, and techniques described below can be implemented.

The neural network system 100 processes a network input 102 that is partitioned into multiple disjoint partitions 104 to generate a network output 112 for a machine learning task.

For example, the network input 102 can be an image and the disjoint partitions can be different non-overlapping regions of the image. In this example, the network output 112 can be an object detection output that identifies regions in the image that depict objects, an image segmentation output that assigns a respective category label to each pixel in the image, or an image classification output that classifies the image into one or more object classes from a set of object classes.

As another example, the network input 102 can be a video and the disjoint partitions can be different sets of video frames from the video or different space-time regions from the video. In this example, the network output 112 can be any appropriate video understanding output, e.g., an action recognition output that identifies one or more actions being performed in the video, a topic classification output that identifies one or more topics to which the video relates, an object detection output that identifies regions in video frames that depict objects, a video segmentation output that assigns a respective category label to each pixel in one or more of the video frames of the video, and so on.

As another example, the network input 102 can be other input from a sensor measuring characteristics of a physical environment. The disjoint partitions can be, for example, different sets of temporally distinct measurements or measurements of different regions in space. The sensor may be any appropriate sensor and the network input 102 may include, by way of example only, measurements of light, temperature, radar, sonar, LIDAR, haptic feedback, electrical resistance, voltage, current, acceleration, chemical make-up, etc.

In this example, the network output 112 can be any output characterizing the physical environment, e.g., a recognition output that identifies one or more characteristics of the environment, a categorization output that assigns a respective category label to each of a series of environments, and so on. The task may include selection of an action to be performed by a mechanical agent, for example in response to identification of a characteristic or assignment of a category, or may be used to detect or predict a fault condition or other condition.

As another example, the network input 102 can be input from a sensor measuring a position or state of a mechanical agent, i.e. proprioception or pose. The disjoint partitions can be, for example, different measurements of different portions (e.g. actuators, limbs) of the mechanical agent or different sets of temporally distinct measurements. In this example, the network output 112 can be any output characterizing a state of the mechanical agent, a categorization output that assigns a respective category label to each portion of the mechanical or to a series or poses of the mechanical agent.

As another example, the network input 102 can be a multi-modal input that includes multiple different modalities and each partition can be a different one of the multiple modalities. In general the multimodal processing task may correspond to any of the tasks previously described for any of the types of data making up the multimodal combination. For example, an accuracy of the previously described tasks may be increased when the task is applied to multimodal data combining the data for which the task has been previously described and another type of data. For example detection or classification of an object or event may be improved when data of multiple different types (modalities) is processed.

For example, the multi-modal input can include two or more of any of the inputs described above, such as images, video, text, and audio.

In these cases, the machine learning task can be any appropriate multi-modal task and the network output 112 can include any appropriate multi-modal task output.

For example, when the input 102 includes a video or an image and text, the network output 112 can be a text sequence that answers a question posed by the text about the video or image or an edited video or image that has been edited as described in the text.

As another example, when the input 102 includes video and audio, the audio can be an audio soundtrack for the video and the network output 112 can be an output for a classification task, e.g., that classifies the topic of the video, that classifies the audio event class in the audio soundtrack, that classifies one or more types of object emitting noise in the audio, that classifies one or more actions being performed in the video, and so on.

As another example, when the input 102 includes video and audio, the audio can be an audio soundtrack for the video and the network output 112 can be an output for a speech recognition task, e.g., can transcribe speech present in the audio soundtrack, for a speech isolation task, e.g., can output isolated speech signals for one or more speakers in the audio soundtrack, and so on.

In particular, the system 100 obtains a network input 102 and determines a plurality of disjoint partitions of the network input using a partitioning engine 104.

If the network input 102 is a multi-modal input, the plurality of disjoint partitions can be different modalities of the input.

If the network input 102 is a tensor that is of a single modality, the plurality of disjoint partitions 104 can be different portions of the tensor.

For each partition 104, the system 100 generates, from the partition, a respective set of latent tokens 106 for the partition. For example, the system 100 can process the partition using a corresponding encoder neural network to generate the latent tokens.

As used in this specification, a “token” is a vector or other ordered collection of numerical values that has a fixed dimensionality, i.e., the number of values in the ordered collection is constant across different tokens.

The system 100 also generates a set of fused latent tokens 108.

For example, the fused latent tokens 108 can each be composed of pre-determined values or can be learned during training.

The system 100 processes the respective set of latent tokens 106 for each partition and the set of fused latent tokens 108 using a neural network 110 to generate the network output 112 characterizing the network input 102.

The neural network 110 includes a sequence of neural network blocks 120 that includes (i) one or more attention blocks 130 and (ii) an output block 140.

Each attention block 130 updates the latent tokens using partitioned attention, i.e., using a respective attention mechanism for each partition and for the fused tokens.

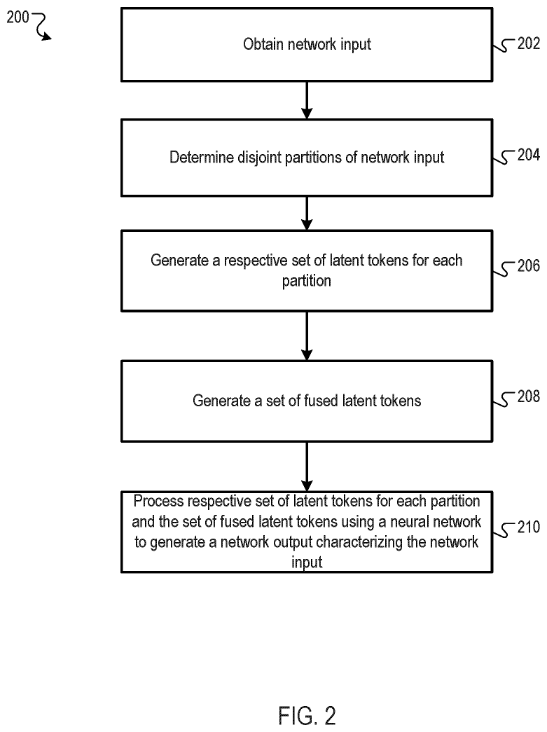

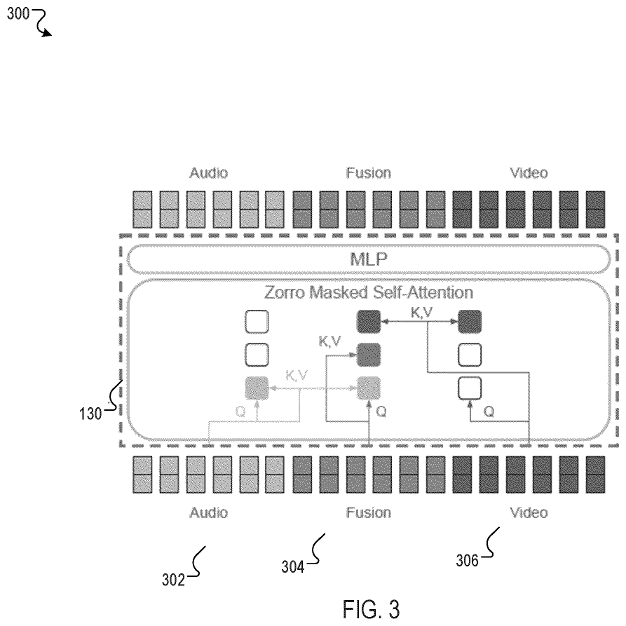

Updating latent tokens using partitioned attention will be described in more detail below with reference to FIGS. 2 and 3.

Each attention block 130 can also perform additional operations, e.g., one or more of normalization operations, skip connection operations, feedforward layer operations, and so on, when updating the latent tokens.

After the respective sets of latent tokens 106 and the fused latent tokens 108 are updated using the one or more attention blocks 130, the output block 140 processes at least one or more of the latent tokens 106, 108 to generate the network output 112 characterizing the network input 102.

In some implementations, the output block 140 generates a single network output (from at least one or more of the latent tokens 106, 108) and then uses the single network output as the network output 112. For example, the output block 140 can generate, as the single output, a fused output generated from only one or more of the fused tokens (and not any tokens for any of the partitions) or a combined (“global”) output generated from all of the latent tokens. As another example, when a partition-specific output is required, e.g., when data from the other partition(s) is missing, the output block 140 can generate, as the single output, a partition output for the specified partition generated from only one or more of the tokens for the partition (and not any tokens for any other partitions or the fused tokens).

In some other implementations, the output block 140 generates multiple candidate network outputs and then combines the candidate network outputs, e.g., averages the network outputs, to generate the final network output 112.

For example, the output block 140 can generate two or more of: a fused output generated from only one or more of the fused tokens (and not any tokens for any of the partitions), a respective partition output for each partition generated from only one or more of the tokens for the partition (and not any tokens for any other partitions or the fused tokens), or a combined (“global”) output generated from all of the latent tokens.

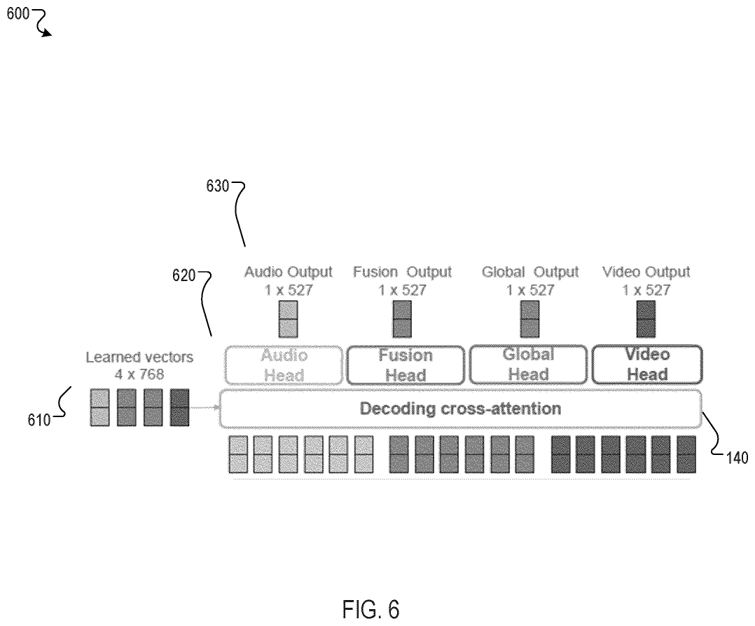

The operations performed by the output block 140 to generate an output are described below with reference to FIG. 6.

FIG. 2 is a flow diagram of an example process 200 for processing a network input to generate a network output. For convenience, the process 200 will be described as being performed by a system of one or more computers located in one or more locations. For example, a neural network system, e.g., the neural network system 100 depicted in FIG. 1, appropriately programmed in accordance with this specification, can perform the process 200.

The system obtains a network input (step 202).

The system determines a plurality of disjoint partitions of the network input (step 204).

For each partition, the system generates, from the partition, a respective set of latent tokens for the partition (step 206).

For example, for each partition, the system can process the partition of the network input using an encoder neural network for the partition to generate the respective set of latent tokens for the partition.

As a particular example, the system can divide the partition into patches and then process each patch using the encoder neural network for the partition to generate a latent token.

When each partition is from the same modality, the system can use the same encoder neural network for each modality. When the partitions are from different modalities, the system can use different encoder neural networks for different partitions. For example, the encoder neural networks can include any of convolutional neural networks, multi-layer perceptron (MILPs), or shallow neural networks that only include a single neural network layer, e.g., a single linear layer or a single convolutional layer.

Optionally, the system can modify each latent token generated by processing the partition of the network input using the encoder neural network using a positional encoding, e.g., by summing or averaging each latent token with the corresponding positional encoding. The positional encodings generally identify, for each patch of each partition, the position of the patch within the partition and which partition the patch belongs to. For example, the system can arrange the latent tokens for all of the modalities (and optionally the fused latent tokens) as a sequence and assign, to each latent token, a positional encoding corresponding to the position of the latent in the sequence.

The positional encodings can be learned jointly with the training of the neural network or can be predetermined, e.g., can be sinusoidal or Fourier positional encodings. Alternatively, the positional encoding can be a combination, e.g., a sum, of a learned positional encoding and a predetermined position encoding.

The system generates a set of fused latent tokens (step 208). For example, the set of fused latent tokens can be learned jointly during the training of the neural network. As described above, the system can optionally also modify the fused latent tokens with a positional encoding.

The system processes the respective set of latent tokens for each partition and the set of fused latent tokens using a neural network to generate a network output characterizing the network input (step 210).

As described above, the neural network generally includes a sequence of neural network blocks that includes (i) one or more attention blocks and (ii) an output block.

Each attention block updates the latent tokens, i.e., the set of latent tokens for each partition and the fused latent tokens.

As part of updating the latent tokens, for each partition, the block updates the respective set of latent tokens for the partition by applying a corresponding attention mechanism for the partition that attends over only the respective set of latent tokens for the partition.

The attention block also updates the set of fused latent tokens by applying a corresponding fused attention mechanism that attends over the respective sets of latent tokens for each of the partitions and the set of fused latent tokens.

One example of the corresponding attention mechanisms for the attention blocks is described below with reference to FIG. 3.

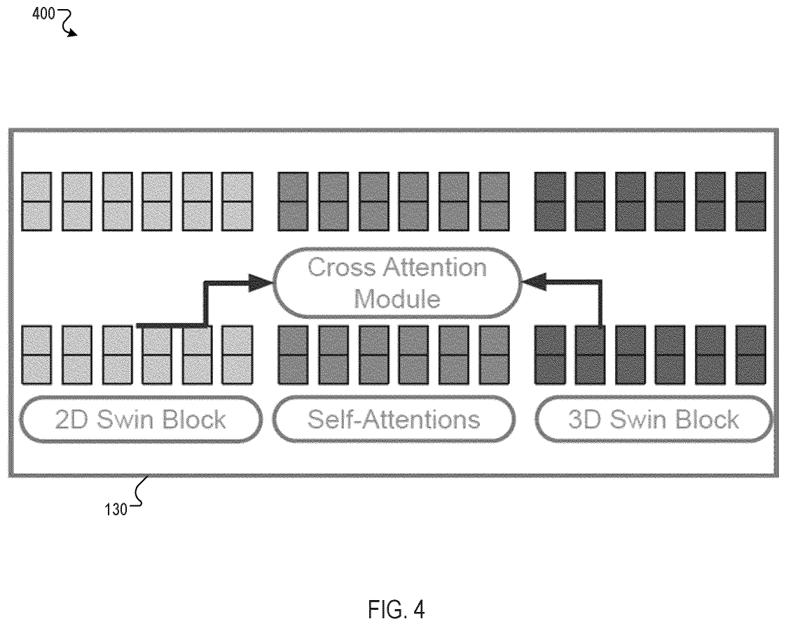

Another example of the corresponding attention mechanisms for the attention blocks is described below with reference to FIG. 4.

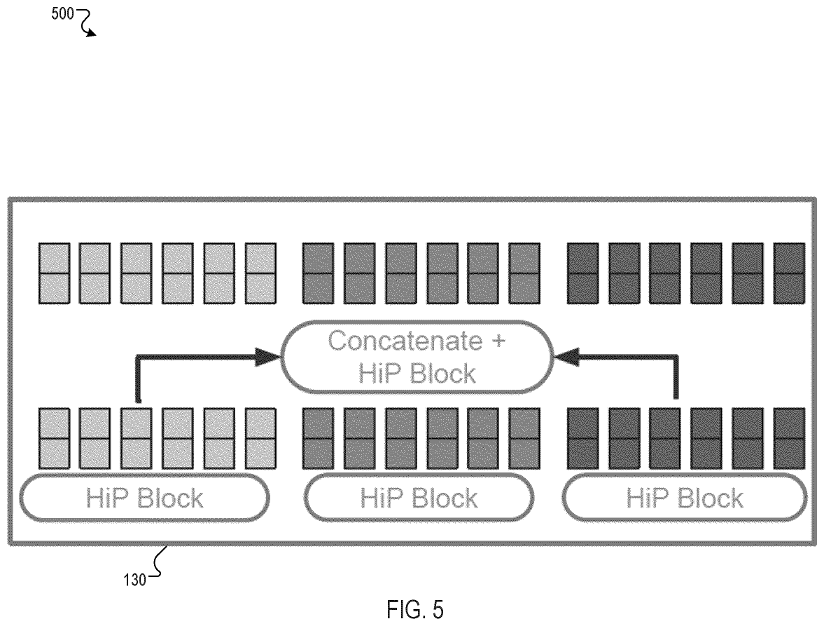

Yet another example of the corresponding attention mechanisms for the attention blocks is described below with reference to FIG. 5.

After the respective sets of latent tokens and the fused latent tokens are updated using the one or more attention blocks, the output block processes at least one or more of the fused latent tokens to generate the network output characterizing the network input.

In some implementations, the output block generates the network output by applying a cross-attention mechanism.

An example of generating a network output through cross-attention is described below with reference to FIG. 6.

FIG. 3 shows an example architecture 300 of an attention block 130.

In the example of FIG. 3, the input is a multi-modal input that includes two modalities: audio and video. Therefore, the input to the attention block 130 includes a set of latent tokens 302 for the audio modality, the fused latent tokens 304 and a set of latent tokens 306 for the video modality.

In the example of FIG. 3, the corresponding attention mechanism for each partition and for the fused latent tokens is the same self-attention mechanism, i.e., the corresponding attention mechanisms for the partitions and the fused latent tokens share parameters and can be computed in parallel. However, the attention block incorporates masking to regulate the information flow between partitions. In particular, the attention block incorporates masking to ensure that, for each partition, the partition tokens are updated using only the tokens from that partition (and not the tokens for any other partition or the fused latent tokens) while the latent fused tokens are updated using all of the tokens from all of the partitions and the latent tokens.

In particular, in the example of FIG. 3, for each partition, the corresponding attention mechanism for the partition is a self-attention mechanism with a partition-specific masking that restricts the attention mechanism to attend over only the respective set of latent tokens for the partition and, for the fused latent tokens, the corresponding attention mechanism is a self-attention mechanism that is not masked to allow the attention mechanism to attend over the respective sets of latent tokens for each of the partitions and the respective set of fused latent tokens.

In particular, the attention block can implement the above-described attention mechanism by introducing a masking binary tensor m into each computation of attention weights, e.g., within each attention head of attention block 130. This masking tensor is applied to the standard attention operation oᵢ=Σⱼaᵢⱼvᵢ, which becomes oᵢ=Σⱼâᵢⱼvᵢ where vᵢ is a value vector for token i, aᵢⱼ is an attention weight between a query q for token i and keys k for the j positions along which the attention is applied, and âᵢⱼ is:

$${\hat{a}}_{ij} = \frac{{m}_{ij} exp ( \frac{{q}_{i}^{{T}_{{k}_{j}}}}{\sqrt{D}} )}{{\sum }_{\{ {j}^{′} , {m}_{ij}^{′} = 1 \}} exp ( \frac{{q}_{i}^{{T}_{{k}_{j}}}}{\sqrt{D}} )} ,$$

where D is a constant value, e.g., the dimensionality of the query, key and value vectors, and where mᵢⱼ is equal to 1 if j is one of the fusion tokens, otherwise mᵢⱼ is only equal to 1 if i and j are from the same partition and is equal to 0 otherwise.

Thus, each latent token for each partition is only updated using the latent tokens for that partition while the fused latent tokens are updated using the latent tokens for all of the partitions and the fused latent tokens.

FIG. 4 shows another example architecture 400 of an attention block 130.

In the example of FIG. 4, the input is a multi-modal input that includes two modalities. Therefore, the input to the attention block 130 includes a set of latent tokens for the first modality, the fused latent tokens and a set of latent tokens for the second modality.

In the example of FIG. 4, the corresponding attention mechanisms for each partition and for the fused latent tokens are different self-attention mechanisms.

In particular, the attention block updates the latent tokens for each partition using a corresponding self-attention mechanism for the latent tokens that only attends over the latent tokens in that partition.

For the fused latent tokens, the self-attention mechanisms includes two individual mechanisms (i) a self-attention mechanism that updates each fused latent token through self-attention over the fused latent tokens and (ii) a cross-attention mechanism that uses the fused latent tokens (as updated by (i)) to cross-attend into the latent tokens for the partitions after those tokens have been updated by their corresponding self-attention mechanisms.

Thus, each latent token for each partition is only updated using the latent tokens for that partition while the fused latent tokens are updated using the latent tokens for all of the partitions and the fused latent tokens.

Structuring the attention block as shown in FIG. 4 allows different types of self-attention to be used for each of the partitions, e.g., to leverage different structure in the underlying data. For example, as shown in FIG. 4, one partition can correspond to an audio modality while the other can correspond to a video modality. The system can use one attention mechanism for the audio modality while using a different attention mechanism for the video modality.

In the example of FIG. 4, the system uses a 2D Swin Transformer block as the attention mechanism for the audio modality because of the 2D structure of the input space of audio spectrograms. For the video modality, the system uses a 3D Swin Transformer block as the attention mechanism to leverage the 3D structure of the input space of video frames.

Generally, Swin Transformer blocks differ from standard self-attention blocks because, for each token, Swin Transformer blocks only apply the self-attention operations to nearby tokens instead of all tokens in the partition. A 2D Swin Transformer block applies the self-attention operations to an (a, b) patch, i.e., a 2 dimensional (2D) patch, of nearby tokens. A 3D Swin Transformer block, on the other hand, applies the self-attention operations to an (a, b, c) patch, i.e., a 3 dimensional (3D) patch, of nearby tokens. Swin Transformer blocks are described in more detail in Ze Liu, Han Hu, Yutong Lin, Zhuliang Yao, Zhenda Xie, Yixuan Wei, Jia Ning, Yue Cao, Zheng Zhang, Li Dong, et al. Swin transformer v2: Scaling up capacity and resolution. arXiv preprint arXiv:2111.09883, 2021.

FIG. 5 shows yet another example architecture 500 of an attention block 130.

Like in the example of FIGS. 3 and 4, the input is a multi-modal input that includes two modalities. Therefore, the input to the attention block includes a set of latent tokens for the first modality, the fused latent tokens and a set of latent tokens for the second modality.

In the example of FIG. 5, the corresponding attention mechanisms for each partition and for the fused latent tokens are based on Hierarchical Perceiver (HiP) attention blocks.

A HiP attention block operates by splitting the inputs to the block into groups and, for each group, applying cross-attention with a set of learned query vectors for the group to generate a set of latent vectors and then operating self-attention only within the latent vectors for the group. The latent vectors are then merged to generate the input for the next network component, e.g., the next HiP attention block. By arranging such blocks in a hierarchical architecture, a Hierarchical Perceiver neural network can fuse groups together in order to aggregate information and globally reason about the input. HiP blocks are described in more detail in Joao Carreira, Skanda Koppula, Daniel Zoran, Adria Recasens, Catalin Ionescu, Olivier Henaff, Evan Shelhamer, Relja Arandjelovic, Matt Botvinick, Oriol Vinyals, et al. Hierarchical perceiver. arXiv preprint arXiv:2202.10890, 2022.

The example architecture 500 includes a separate HiP attention block for each partition. That is, the corresponding attention mechanism for each partition is implemented as a separate HiP block for each partition.

Thus, the attention block 130 processes the latent tokens for each partition using a HiP attention block for the partition to update the latent tokens for the partition.

For the fusion tokens, the attention block 130 includes two separate HiP blocks. The block 130 processes only the fusion latent tokens using a first HiP block to update the fusion latent tokens. After the first HiP block, the attention block 130 concatenates the latent tokens for the partitions and the fusion latent tokens to generate a combined sequence and processes the combined sequence using the HiP block to update the fusion latent tokens, but not the latent tokens for the partitions.

Thus, the corresponding attention mechanism for the fusion latent tokens is implemented as a first HiP block that operates on the fusion latent tokens and a second HiP block that operates on the combined sequence.

Thus, each latent token for each partition is only updated using the latent tokens for that partition, i.e., by being processed by the HiP block for the partition, while the fused latent tokens are updated using the latent tokens for all of the partitions and the fused latent tokens, i.e., by virtue of the combined sequence being processes by the second HiP block for the fusion latent tokens.

The system can achieve the hierarchical fusion across the entire input by modifying the number of blocks used by the HiP blocks within different attention blocks 130. For example, when the neural network 110 includes a sequence of five attention blocks 130, the number of groups can be as follows: (32; 4; 1; 1; 1). Thus, in this example, the HiP blocks within the last three attention blocks 130 operate on the entire set of latent tokens that are received as input by the HiP block.

FIG. 6 shows an example 600 of the operations performed by the output block 140.

In the example of FIG. 6, the output block 140 generates network outputs by making use of cross-attention.

In particular, in the example of FIG. 6, for any given input, the output block 140 can generate one or more of three different types of outputs 630: (1) a partition-specific output that is generated using only the latent tokens for a single partition, (2) a fusion output that is generated using only the fusion latent tokens, or (3) a global output that is generated using all of the latent tokens, i.e., the latent tokens for all of the partitions and the fusion latent tokens.

In some cases, the output block 140 is only configured to generate a fusion output or a global output, but not both.

Similarly, in some cases, after training, the output block 140 is only configured to generate one or more of the fusion output or the global output, but not any partition-specific outputs.

Thus, the output block 140 maintains a respective set of learned query vectors 610 for each partition, for the fusion latent tokens, and for the global output and a respective output head 620 for each output 630. The learned query vectors 610 are learned jointly with the training of the neural network 110.

To generate an output for a given partition, the output block 140 applies cross-attention using the learned query vectors for the partition into the latent tokens for the partition to update the learned query vectors. The output block 140 can then use a partition-specific head that applies one or more appropriate learned transformations to the one or more updated learned query vectors to map the learned query vectors to an output for the machine learning task. For example, the output block 140 can process each learned query vector using one or more linear layers, an activation function layer, a softmax layer, or some combination of the above.

To generate the fusion output, the output block 140 applies cross-attention using the learned query vectors for the fusion latent tokens into the fusion latent tokens to update the learned query vectors. The output block 140 can then use a fusion head that applies one or more appropriate learned transformations to the one or more updated learned query vectors to map the learned query vectors to an output for the machine learning task. For example, the output block 140 can process each learned query vector using one or more linear layers, an activation function layer, a softmax layer, or some combination of the above.

To generate the global output, the output block 140 applies cross-attention using the learned query vectors for the global output into all of the latent tokens to update the learned query vectors. The output block 140 can then use a global head that applies one or more appropriate learned transformations to the one or more updated learned query vectors to map the learned query vectors to an output for the machine learning task. For example, the output block 140 can process each learned query vector using one or more linear layers, an activation function layer, a softmax layer, or some combination of the above.

In the example of FIG. 6, the task is a classification task that requires classifying an input into one or more of 527 categories. Thus, each output is a 1×527 vector of scores, e.g., probabilities. Similarly, each set of learned query vectors includes a single query vector and each output head maps the corresponding single updated learned query vector to the 1×527 vector of scores.

Thus, the partition-specific outputs depend only a single given partition, while the fusion outputs and the global outputs incorporate information from the entire input.

Prior to using the neural network 110 to perform the machine learning task, a training system trains the neural network 110 to perform the task, i.e., to determine trained values of the parameters of the neural network, i.e., of the attention blocks in the sequence and the output block, and, optionally, the encoder neural network(s) used to generate the latent tokens. For example, the training system can train the neural network from scratch on training data for the task to minimize a loss function for the task, e.g., a cross-entropy loss, a negative log likelihood loss, and so on using conventional machine learning techniques. As another example, the training system can first pre-train the neural network on an unsupervised objective and then fine-tune the neural network on the training data for the task. As yet another example, the training system can train the neural network on both unlabeled data and the training data for the task through semi-supervised learning.

During training, the training system can incorporate any number of techniques to improve the speed, the effectiveness, or both of the training process. For example, the system can use dropout, label smoothing, or both to reduce overfitting. As another example, the system can perform the training using a distributed architecture that trains multiple instances of the neural network in parallel.

Moreover, as described above, the system can first pre-train the neural network on a large unsupervised data set through self-supervised or unsupervised learning and then fine-tune the neural network on task-specific training data to optimize the loss function for the task.

In particular, because of the architecture of the neural network, the neural network is particularly adapted to being trained using un-supervised or self-supervised objectives, either as a pre-training step or as an auxiliary loss to the supervised training, even when the inputs to the neural network are multi-modal.

Additionally, after training, the neural network 110 can be used to process both inputs that include only a single partition, e.g., uni-modal inputs, and multi-modal inputs.

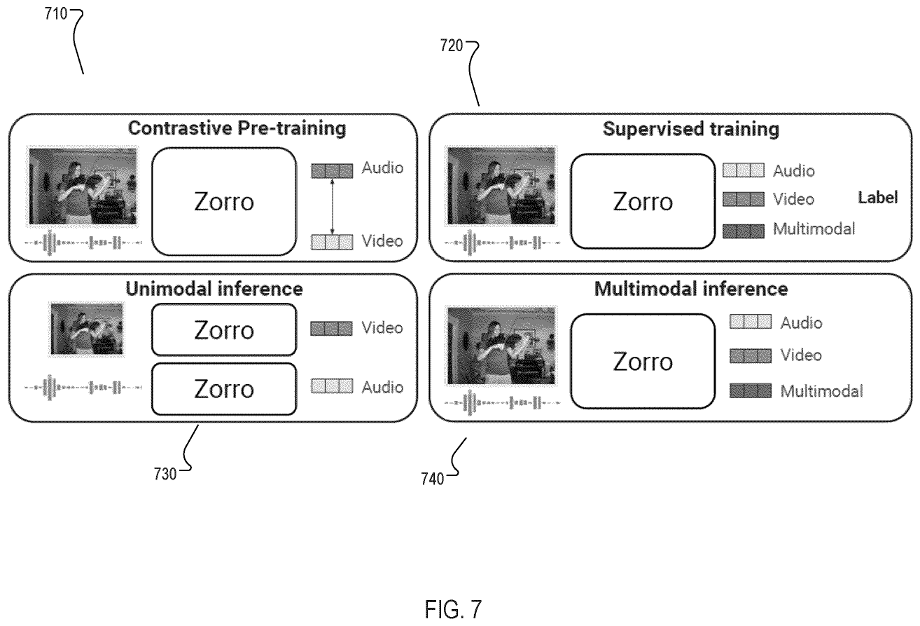

FIG. 7 shows an example of various uses of the neural network 110.

As shown in FIG. 7, the neural network, referred to as “Zorro” in the Figure, can be used for both multimodal inference 740 and unimodal inference 730 after training, even if the neural network was only trained to perform a multi-modal task or a uni-modal task (and not both).

To use the neural network for multimodal inference 740, i.e., where the input includes two or more modalities, each of which is assigned into a different partition, the system uses the output block to generate a fusion output, a global output, or both. Further optionally, the system can also generate a respective partition-specific output for each partition. The system can then either use, as the network output, the fusion output or the global output, or when multiple outputs are generated, combine the outputs as described above to generate the network output.

To use the neural network for unimodal inference 730, i.e., where the input includes only one modality, and that modality is assigned to a single partition, the system can proceed as follows.

In particular, the system can receive a network input that includes only a first modality of the plurality of modalities. The system can generate a set of latent tokens for the partition corresponding to the first modality as described above. The system can then process the set of latent tokens for the partition corresponding to the first modality using the neural network, by, for each attention block, updating the set of latent tokens for the partition corresponding to the modality by applying a corresponding attention mechanism for the partition that attends over only the respective set of latent tokens for the partition. After the sets of latent token for the corresponding modality are updated using the one or more attention blocks, the system can process one or more latent tokens from the set of latent tokens for the corresponding modality using the output block to generate the network output characterizing the network input. Thus, the neural network does not need to perform the operations of the attention blocks for the other modalities or for the fusion tokens.

During training of the neural network, the system can use the neural network to perform both contrastive pre-training (an unsupervised task) 710 and supervised training 720.

To perform supervised training on a given training example that includes a training input and a label, the system can use the neural network to generate the fusion output and each of the modality specific outputs (and optionally the global output) for the training input. The system can then compute a respective loss between the label and all of the generated outputs and use gradients of all of the respective losses to update the parameters of the neural network. This can give a richer training signal than only using a single, multi-modal output and can also allow the neural network to effectively perform uni-modal inference after training.

Multi-modal contrastive methods learn representations by aligning the multiple modalities into a common embedding space. As opposed to unimodal approaches, instead of producing multiple views of the data, multi-modal contrastive methods use different modalities as views. One important requirement is for the two components of the neural networks that generate embeddings to not share information. If information is shared across modalities, the self-supervised training can easily collapse or converge to a trivial solution.

Conventional models for multimodal perception typically produce a single output for the multiple inputs. This is sufficient for supervised applications, but prevents the use of these contrastive techniques. The ability of the neural network to generate both unimodal and multimodal outputs, however, enables the effective use of self-supervised contrastive losses.

For training with a contrastive loss, e.g., a noise-contrastive estimation loss, the system applies, for each modality, a final linear projection (different per modality) to the output of the cross-attention performed by the output block for that modality to yield final embedding vectors for each modality. The system can then use these final embedding vectors to compute the contrastive loss, e.g., the noise-contrastive estimation loss or other contrastive learning loss that measures similarities between embeddings. To train any parameters specific to the fusion representation or output (e.g., the fusion cross-attention or the fusion weights if the model has separate weights per modality), the system can add a respective fusion contrastive loss for each modality. The fusion loss for a given modality is a contrastive loss that takes as input a final fusion embedding computed from the fusion latent vectors as described above and the final embedding for the given modality. For example, when there are two input modalities, the overall contrastive loss can be a sum or a weighted sum between the contrastive loss between the two input modalities and the fusion contrastive losses for the two input modalities.

When the fusion latent vectors are learned, during supervised, un-supervised, or self-supervise training, the system can also update the fusion latent vectors, e.g., by backpropagating gradients of the loss function through the neural network and into the fusion latent vectors.

When the system also trains one or more encoder neural networks jointly with the training of the neural network, the system can also update the encoder neural network(s) by backpropagating gradients of the loss function through the neural network and into the encoder neural network(s).

TABLE 1
Pre-training Sup. Pretraining Training Set Modalities mAP

| Model | Pre-training Sup. | Pretraining | Training Set | Modalities | mAP |
|---|---|---|---|---|---|
| AST [22] | IN-21k | ✓ | AudioSet | A | 45.9 |
| GBlend [45] | IG-65 | ✓ | AudioSet | A + V | 37.8 |
| Attn Audio-Visual [16] | ImageNet | ✓ | AudioSet | A + V | 46.2 |
| MBT [30] | IN-21k | ✓ | AudioSet-500k | A + V | 52.1 |
| Zorro | YT8M | ✓ | AudioSet | A + V | 50.6 |
| Zorro | YT8M | ✓ | AudioSet-500k | A + V | 51.6 |
| ERANN [44] | x | ✓ | AudioSet | A | 45.0 |
| Perceiver [24] | x | x | AudioSet | A + V | 44.2 |
| Zorro | x | x | AudioSet | A + V | 44.8 |
| Zorro | AudioSet | x | AudioSet-500k | A + V | 47.5 |
| Zorro | YT8M | x | AudioSet | A + V | 48.8 |
| Zorro | YT8M | x | AudioSet-500k | A + V | 48.8 |

TABLE 2

| Model | Pre-training | Sup. Pre-training | Modalities | Top-1 | Top-5 |
|---|---|---|---|---|---|
| ResNet-50 [14] | x | x | A | 51.0 | 76.4 |
| AudioSlowFast [25] | x | x | A | 52.5 | 78.1 |
| MBT [30] | ImageNet-21k | ✓ | A + V | 64.1 | 85.6 |
| Zorro | YT8M | x | A + V | 64.2 | 85.5 |
| Zorro | YT8M | ✓ | A + V | 66.2 | 86.3 |

Tables 1 and 2 show the performance of the described neural network (“Zorro”) on various tasks that require processing audio (A), video (V), or multi-modal inputs that require processing A and V and under various self-supervised pre-training (“pre-training”) and supervised pre-training (“Sup. Pre-training”). In Tables 1 and 2, when both audio and video are processed, the task is audio-video classification and when only audio is processed, the task is audio classification. As can be seen from Tables 1 and 2, Zorro achieves results that match or exceed those of a variety of baselines (all of the models not labeled “Zorro” in the Tables) on a variety of tasks in a variety of regimes both in terms of top-1 accuracy (“top-1”) and top-5 accuracy (“top-5”). That is, the described architecture is flexible enough to generate high quality results in any of a variety of training regimes without requiring modifications to the architecture. Moreover, after training, the described architecture can effectively be used to perform uni-modal processing even if the training data was all multi-modal.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, .e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

There are now set out a number of statements describing examples of the subject matter described herein.

1. A method performed by one or more computers, the method comprising:
obtaining a first network input;
determining a plurality of disjoint partitions of the first network input;
for each partition, generating, from the partition, a respective set of latent tokens for the partition;
generating a set of fused latent tokens;
processing the respective set of latent tokens for each partition and the set of fused latent tokens using a neural network to generate a network output characterizing the first network input,
wherein the neural network comprises a sequence of neural network blocks comprising: (i) one or more attention blocks and (ii) an output block,
wherein each attention block performs operations comprising:
   for each partition, updating the respective set of latent tokens for the partition by applying a corresponding attention mechanism for the partition that attends over only the respective set of latent tokens for the partition; and
   updating the set of fused latent tokens by applying a corresponding fused attention mechanism that attends over the respective sets of latent tokens for each of the partitions and the set of fused latent tokens; and
wherein the output block performs operations comprising:
   after the respective sets of latent tokens and the fused latent tokens are updated using the one or more attention blocks, processing at least one or more of the latent tokens to generate the network output characterizing the first network input.
      2. The method of example 1, wherein each disjoint partition corresponds to a different modality from a plurality of modalities.
      3. The method of example 2, wherein the modalities include an image modality, a video modality, or both.
      4. The method of example 2 or example 3, wherein the modalities include an audio modality.
      5. The method of any one of examples 2-4, wherein the modalities include a text modality.
      6. The method of any one of examples 2-5, further comprising:
receiving a second input that includes only a first modality of the plurality of modalities;
generating a set of latent tokens for the partition corresponding to the first modality;
processing the set of latent tokens for the partition corresponding to the first modality using the neural network, comprising,
   for each attention block, updating the set of latent tokens for the partition corresponding to the modality by applying a corresponding attention mechanism for the partition that attends over only the respective set of latent tokens for the partition; and
   after the sets of latent token for the corresponding modality are updated using the one or more attention blocks, processing one or more latent tokens from the set of latent tokens for the corresponding modality to generate the network output characterizing the second network input.
      7. The method of any preceding example, wherein the fused latent tokens are learned during the training of the neural network.
      8. The method of any preceding example, wherein for each partition, generating, from the partition, a respective set of latent tokens for the partition comprises:
processing the partition of the first network input using an encoder neural network for the partition to generate the respective set of latent tokens for the partition.
   9. The method of example 8, wherein for each partition, generating, from the partition, a respective set of latent tokens for the partition further comprises:
modifying each latent token generated by processing the partition of the first network input using the encoder neural network using a positional encoding.
   10. The method of example 8 or example 9, wherein for each partition, generating, from the partition, a respective set of latent tokens for the partition further comprises:
augmenting the latent tokens generated by processing the partition of the first network input using the encoder neural network with one or more learned tokens.
   11. The method of any preceding example, wherein:
for each partition, the corresponding attention mechanism for the partition is a self-attention mechanism with a partition-specific masking that restricts the attention mechanism to attend over only the respective set of latent tokens for the partition; and
for the fused latent tokens, the corresponding attention mechanism is a self-attention mechanism that is not masked to allow the attention mechanism to attend over the respective sets of latent tokens for each of the partitions and the respective set of fused latent tokens.
   12. The method of example 11, wherein the corresponding attention mechanisms for the partitions and the fused latent tokens share parameters.
   13. The method of any preceding example, wherein processing at least one or more of the fused latent tokens to generate the network output characterizing the first network input comprises:
generating a fused network output from one or more latent tokens selected only from the fused latent tokens.
   14. The method of any preceding example, wherein processing at least one or more of the fused latent tokens to generate the network output characterizing the first network input comprises:
generating an overall network output from one or more latent tokens selected from the fused latent tokens and the sets of latent tokens for each of the partitions.
   15. The method of any preceding example, wherein processing at least one or more of the fused latent tokens to generate the network output characterizing the first network input comprises:
generating two or more candidate network outputs, the two or more candidate network output comprising at least one candidate network output generated using one or more of the fused latent tokens; and
combining the two or more candidate network outputs to generate a final network output.
   16. A method of training a neural network performed by one or more computers, the method comprising:
obtaining a first network input;
determining a plurality of disjoint partitions of the first network input;
for each partition, generating, from the partition, a respective set of latent tokens for the partition;
generating a set of fused latent tokens;
processing the respective set of latent tokens for each partition and the set of fused latent tokens using a neural network to generate a network output characterizing the first network input,
wherein the neural network comprises a sequence of neural network blocks comprising: (i) one or more attention blocks and (ii) an output block,
wherein each attention block performs operations comprising:
   for each partition, updating the respective set of latent tokens for the partition by applying a corresponding attention mechanism for the partition that attends over only the respective set of latent tokens for the partition; and
   updating the set of fused latent tokens by applying a corresponding fused attention mechanism that attends over the respective sets of latent tokens for each of the partitions and the set of fused latent tokens; and
wherein the output block performs operations comprising:
   after the respective sets of latent tokens and the fused latent tokens are updated using the one or more attention blocks, processing at least one or more of the fused latent tokens to generate the network output characterizing the first network input
comparing network output to an expected network output for the first network input to determine a loss and training the neural network based on a loss.
   17. The method of example 16, wherein generating the respective set of latent tokens for the partition and/or generating the set of fused latent tokens comprises processing the first network input with an encoder neural network trained to generate the respective set of latent tokens for each partition and/or generate the set of fused latent tokens; and
wherein training the neural network based on the loss comprises training the encoder neural network.
   18. The method of example 16 or 17, further comprising pre-training the neural network using an unsupervised dataset using a self-supervised or unsupervised learning objective.
   19. The method of example 16, 17 or 18, wherein determining a loss comprises using an unsupervised or self-supervised loss function as an auxiliary loss function.
   20. A method performed by one or more computers, the method comprising:
obtaining a first unimodal network input;
processing the unimodal input using a neural network trained in accordance with any one of examples 16 to 19 to generate a network output characterizing the first unimodal network input.
   21. A system comprising one or more computers and one or more storage devices storing instructions that when executed by the one or more computers cause the one more computers to perform the operations of the respective method of any one of examples 1-20.
   22. One or more computer storage media storing instructions that when executed by one or more computers cause the one more computers to perform the operations of the respective method of any one of examples 1-20.

1. A method performed by one or more computers, the method comprising:
obtaining a first network input;
determining a plurality of disjoint partitions of the first network input;
for each partition, generating, from the partition, a respective set of latent tokens for the partition;
generating a set of fused latent tokens;
processing the respective set of latent tokens for each partition and the set of fused latent tokens using a neural network to generate a network output characterizing the first network input,
wherein the neural network comprises a sequence of neural network blocks comprising:
(i) one or more attention blocks and (ii) an output block,
wherein each attention block performs operations comprising:
for each partition, updating the respective set of latent tokens for the partition by applying a corresponding attention mechanism for the partition that attends over only the respective set of latent tokens for the partition; and
updating the set of fused latent tokens by applying a corresponding fused attention mechanism that attends over the respective sets of latent tokens for each of the partitions and the set of fused latent tokens; and
wherein the output block performs operations comprising:
after the respective sets of latent tokens and the fused latent tokens are updated using the one or more attention blocks, processing at least one or more of the fused latent tokens to generate the network output characterizing the first network input.

2. The method of claim 1, wherein each disjoint partition corresponds to a different modality from a plurality of modalities.

3. The method of claim 2, wherein the modalities include an image modality, a video modality, or both.

4. The method of claim 2, wherein the modalities include an audio modality.

5. The method of claim 2, wherein the modalities include a text modality.

6. The method of claim 2, further comprising:
receiving a second input that includes only a first modality of the plurality of modalities;
generating a set of latent tokens for the partition corresponding to the first modality;
processing the set of latent tokens for the partition corresponding to the first modality using the neural network, comprising,
for each attention block, updating the set of latent tokens for the partition corresponding to the modality by applying a corresponding attention mechanism for the partition that attends over only the respective set of latent tokens for the partition; and
after the sets of latent token for the corresponding modality are updated using the one or more attention blocks, processing one or more latent tokens from the set of latent tokens for the corresponding modality to generate the network output characterizing the second network input.

7. The method of claim 1, wherein the fused latent tokens are learned during the training of the neural network.

8. The method of claim 1, wherein for each partition, generating, from the partition, a respective set of latent tokens for the partition comprises:
processing the partition of the first network input using an encoder neural network for the partition to generate the respective set of latent tokens for the partition.

9. The method of claim 8, wherein for each partition, generating, from the partition, a respective set of latent tokens for the partition further comprises:
modifying each latent token generated by processing the partition of the first network input using the encoder neural network using a positional encoding.

10. The method of claim 8, wherein for each partition, generating, from the partition, a respective set of latent tokens for the partition further comprises:
augmenting the latent tokens generated by processing the partition of the first network input using the encoder neural network with one or more learned tokens.

11. The method of claim 1, wherein:
for each partition, the corresponding attention mechanism for the partition is a self-attention mechanism with a partition-specific masking that restricts the attention mechanism to attend over only the respective set of latent tokens for the partition; and
for the fused latent tokens, the corresponding attention mechanism is a self-attention mechanism that is not masked to allow the attention mechanism to attend over the respective sets of latent tokens for each of the partitions and the respective set of fused latent tokens.

12. The method of claim 11, wherein the corresponding attention mechanisms for the partitions and the fused latent tokens share parameters.

13. The method of claim 1, wherein processing at least one or more of the fused latent tokens to generate the network output characterizing the first network input comprises:
generating a fused network output from one or more latent tokens selected only from the fused latent tokens.

14. The method of claim 1, wherein processing at least one or more of the fused latent tokens to generate the network output characterizing the first network input comprises:
generating an overall network output from one or more latent tokens selected from the fused latent tokens and the sets of latent tokens for each of the partitions.

15. The method of claim 1, wherein processing at least one or more of the fused latent tokens to generate the network output characterizing the first network input comprises:
generating two or more candidate network outputs, the two or more candidate network output comprising at least one candidate network output generated using one or more of the fused latent tokens; and
combining the two or more candidate network outputs to generate a final network output.

16. A method of training a neural network performed by one or more computers, the method comprising:
obtaining a first network input;
determining a plurality of disjoint partitions of the first network input;
for each partition, generating, from the partition, a respective set of latent tokens for the partition;
generating a set of fused latent tokens;
processing the respective set of latent tokens for each partition and the set of fused latent tokens using a neural network to generate a network output characterizing the first network input,
wherein the neural network comprises a sequence of neural network blocks comprising:
(i) one or more attention blocks and (ii) an output block,
wherein each attention block performs operations comprising:
for each partition, updating the respective set of latent tokens for the partition by applying a corresponding attention mechanism for the partition that attends over only the respective set of latent tokens for the partition; and
updating the set of fused latent tokens by applying a corresponding fused attention mechanism that attends over the respective sets of latent tokens for each of the partitions and the set of fused latent tokens; and
wherein the output block performs operations comprising:
after the respective sets of latent tokens and the fused latent tokens are updated using the one or more attention blocks, processing at least one or more of the fused latent tokens to generate the network output characterizing the first network input; and
comparing the network output to an expected network output for the first network input to determine a loss and training the neural network based on the loss.

17. The method of claim 16, wherein generating the respective set of latent tokens for the partition comprises processing the first network input with an encoder neural network trained to generate the respective set of latent tokens for each partition.

18. The method of claim 17,
wherein training the neural network based on the loss comprises training the encoder neural network.

19. The method of claim 16, wherein the set of fused latent tokens are learned during the training, and wherein training the neural network based on the loss comprises updating the set of fused latent tokens.

20. The method of claim 16, further comprising pre-training the neural network using an unsupervised dataset using a self-supervised or unsupervised learning objective.

21. The method of claim 16, wherein determining a loss comprises using an unsupervised or self-supervised loss function as an auxiliary loss function.

22. (canceled)

23. A system comprising one or more computers and one or more storage devices storing instructions that when executed by the one or more computers cause the one more computers to perform operations comprising:
obtaining a first network input;
determining a plurality of disjoint partitions of the first network input;
for each partition, generating, from the partition, a respective set of latent tokens for the partition;
generating a set of fused latent tokens;
processing the respective set of latent tokens for each partition and the set of fused latent tokens using a neural network to generate a network output characterizing the first network input,
wherein the neural network comprises a sequence of neural network blocks comprising:
(i) one or more attention blocks and (ii) an output block,
wherein each attention block performs operations comprising:
for each partition, updating the respective set of latent tokens for the partition by applying a corresponding attention mechanism for the partition that attends over only the respective set of latent tokens for the partition; and
updating the set of fused latent tokens by applying a corresponding fused attention mechanism that attends over the respective sets of latent tokens for each of the partitions and the set of fused latent tokens; and
wherein the output block performs operations comprising:
after the respective sets of latent tokens and the fused latent tokens are updated using the one or more attention blocks, processing at least one or more of the fused latent tokens to generate the network output characterizing the first network input.

24. (canceled)
